(19) United States
(12) Patent Application Publication
(10) Pub. No.: US 2008/0141334 A1
(43) Pub. Date: Jun. 12, 2008

(54) Method and Apparatus for Dissociating Binding Information from Objects to Enable Proper Rights Management

(76) Inventors: James M. Wicker, San Jose, CA (US); David S. Coblentz, San Jose, CA (US); Grant H. Williard, Los Altos, CA (US); Matthew J. Poling, San Jose, CA (US)

Correspondence Address: Robert C. Kowert;Meyertons, Hood, Kivlin, Kowert & Goetzel, P.C., P.O. Box 398, Austin, TX, 78767-0398, US

(21) Appl. No.: 11/609,766

(22) Filed: Dec. 12, 2006

(51) Int. Cl. G06F 21/24

(52) U.S. Cl. 726/1

(57) ABSTRACT

Method and apparatus for dissociating binding information from objects to enable proper rights management. Embodiments may provide a rights management mechanism that may be implemented in Computer-Aided Design (CAD) systems. The rights management mechanism dissociates binding information from objects in a CAD assembly to enable rights management at the object level. The rights management mechanism enforces rights at the user level as well as at the object level, and manages and enforces rights at the user level for different CAD operations. Embodiments of the rights management mechanism may include a rights management server and a rights client mechanism. The geometry from a set of files that is instantiated into a CAD session may be interpreted by the rights client mechanism and correlated by the rights management server with the associated files to determine the rights that need to be applied to the parts instantiated from the files.

### BACKGROUND

1. Field of the Invention

This invention relates to computer systems, and more specifically to the digital rights management of collections of objects such as CAD assemblies.

2. Description of the Related Art

Computer-Aided Design (CAD) systems may be used by architects, engineers, drafters, artists, and others to create precision drawings or technical illustrations. CAD software (referred to herein as CAD applications) may be used to create two-dimensional (2-D) drawings or three-dimensional (3-D) models. Closely related CAD/CAM (computer-aided design/computer-aided manufacturing) is software used to design products such as electronic circuit boards in computers and other devices. A variety of CAD systems, CAD software/applications, and CAD hardware are available from a variety of vendors. CAD systems may range from low-end systems intended for personal use that may be implemented and executed as a CAD application on a personal computer to high-end, network-implemented systems, department-wide or possibly even enterprise-wide systems, with multiple high-end CAD workstations, CAD file servers, high-end printers, and possibly other infrastructure and components, and on which CAD objects may be accessed by or shared among various users in the enterprise or possibly even accessed by or distributed to others outside the enterprise.

FIGS. 1A and 1B illustrates a conventional CAD system implemented on a network. In FIG. 1A, one or more CAD stations 120, each implementing CAD software as a CAD application 122, may be coupled to a network 100. A CAD server 110 may be coupled to network 100. CAD server may store and manage CAD files 112. FIG. 1B illustrates the operation of a CAD station 120. A user 150 may interact with CAD application 122 implemented on CAD station 120 to initiate CAD operations. For example, the user 150 may interact with CAD application 122 to open and display a CAD assembly. CAD application 122 may communicate with CAD server 110 to access the desired assembly. CAD server 110 may manage and store an assembly as an assembly file 118. An assembly file 118 may reference other CAD files, such as one or more part files 114 and/or one or more family files 116. Each part file 114 may include information, including but not limited to geometric information, related to a particular part. For the purpose of this document, a part is an atomic CAD element or unit. In CAD, parts may be assembled into an assembly according to defined geometric relationships among the parts. Note that an assembly file may include information related to the geometric relationships among the parts indicated therein, and possibly other information related to the assembly. Thus, an assembly may be considered a geometrically ordered or related collection of parts, and is defined in an assembly file 118. A family file 116 may be a file that indicates a collection of one or more part files 114, and may include other information such as information about relationships among the parts indicated therein.

Once the assembly file 118 has been accessed from the CAD server 110, CAD application 122 may render the assembly 138 on a display 130 coupled to the CAD station 120. In this example, assembly 138 has been rendered on display 130 as a 3-D model that includes, in this view of the assembly 138, parts 134A through 134E ordered according to a geometric relationship as specified in the assembly file 118. User 150 may then manipulate, modify, or perform other operations on the assembly 138 or parts 134 as necessary or desired. For example, the user 150 may add or remove parts 134, move parts 134, modify parts 134, print the assembly 138 or portions thereof, rotate or otherwise change the perspective or view of the assembly 138, view other aspects of the assembly 138 not currently displayed, and so on.

FIG. 2 provides a simplified conceptual illustration of a CAD assembly, such as assembly 138 in FIG. 1B. An assembly 160 may be conceptually viewed as a collection of parts 162 and the relationship among the parts 162. The relationship among the parts 162 may be referred to as binding information. An assembly file 118 may include information identifying parts 162 (e.g., information identifying one or more part files 114 and/or family files 116) and binding information that defines the relationship among the included parts 162. Conceptually, the parts 162 in an assembly 160 may be viewed as a hierarchy of parts, arranged hierarchically from a high level (e.g., a level containing part 162A) down through one or more lower levels. The binding information identifies the hierarchical relationship between the parts 160 as well as relational information among parts within a level.

Access control and security in CAD systems such as the exemplary system of FIGS. 1A and 1B is a concern. For example, in conventional network-based CAD systems, file encryption and account-level password control have been the mechanisms generally used to control access to CAD files. Any user with a valid account and password and with network access may thus access CAD files managed by a CAD file server 110 via a CAD station 120. Thus, conventionally, any such user may modify, copy, print, or otherwise manipulate or use assembly, family, and part files in a CAD session, in spite of the fact that the CAD files may be shared among many users, and the fact that families and parts may be shared among assemblies.

### SUMMARY

Various embodiments of a method and apparatus for dissociating binding information from objects to enable proper rights management are described. Embodiments may provide a rights management mechanism that may be implemented in and/or integrated with Computer-Aided Design (CAD) systems, including network-based CAD systems. An aspect of the rights management mechanism is that the mechanism dissociates the binding information from the objects (e.g., the parts in the assembly) in a structured CAD assembly to enable proper rights management at the object (part) level in CAD environments. Embodiments of the rights management mechanism may manage and enforce rights at all levels, including the atomic object level, and at the different levels or tiers of the hierarchy of parts in a CAD assembly. Another aspect of the rights management mechanism is that the mechanism may manage and enforce rights at the user level as well as at the atomic level within a CAD assembly, and may manage and enforce rights at the user level for different CAD functions or operations at the atomic level within a CAD assembly. This atomic, user-specific rights management enabled by embodiments of the rights management system is not provided in conventional CAD systems.

Embodiments of the rights management mechanism apply rights management in the context of structured CAD assemblies. In a structured CAD assembly, the CAD model may be broken up into a number of objects (parts) in a hierarchical or other structured way. The relationship among those parts is the binding information. In embodiments, each of the parts may be individually assigned rights. The rights management mechanism manages the interrelationship among the rights assigned to the different parts and provides rights management individually for each part. Embodiments of the rights management mechanism provide the ability to examine a structured CAD assembly according to the hierarchy of parts, to separate and examine each part and to determine that the part is a specific object that needs to have rights assigned and recognized. Dissociating objects (parts) of a CAD assembly refers to recognizing the objects in the assembly and separating them out to apply object-level rights management. In dissociating the objects (parts) of a CAD assembly, the rights management mechanism is able to interpret the structure of the assembly to understand the relationships of the parts to each other, and thus can recognize the distinct parts in an assembly.

In embodiments, rights may be managed and applied at the level of CAD files and the content that is contained in the CAD files. Once the geometry in a set of CAD files is instantiated in a CAD session, the rights management system may interpret the geometric relationships among parts and determine that a particular geometry belongs to a particular part and thus to a particular CAD file, and that the part and associated CAD file have certain associated rights. Thus, given the geometry of a CAD session the rights management system is able to determine that that geometry belongs to particular CAD files that have been protected by rights management, and thus apply rights within the CAD session in accordance with the rights assigned to the associated files.

Embodiments of the rights management mechanism may include, but are not limited to, a rights management server and a rights client mechanism. In one embodiment, one or more rights management servers may store and manage rights information for CAD objects, which are typically stored and managed in CAD files on one or more CAD file servers, rights information for the CAD files themselves, and rights information for CAD users. Each CAD station in the networked CAD system may host at least one instance of the rights client mechanism. In one embodiment, the rights client mechanism may be implemented as a plug-in to CAD application software on each CAD station. Alternatively, the rights client mechanism may be implemented as a module or component of the CAD application software.

In one embodiment, end users of the CAD system may assign rights based on a file-by-file basis. Those rights may be associated with the content (including the geometric information) of the files on a rights management server. When the files are packaged, the files include information that points them back to the rights management server that stores and manages the rights definitions. The geometry from a set of files that is instantiated into a CAD session may be interpreted by a rights client mechanism and correlated by the rights management server with the associated files to determine the rights that need to be applied to the parts instantiated from the files in the context of a particular instance of a CAD assembly instantiated in a CAD session.

### BRIEF DESCRIPTION OF THE DRAWINGS

FIGS. 1A and 1B illustrates a conventional CAD system implemented on a network.

FIG. 2 provides a conceptual illustration of a CAD assembly.

FIG. 3 illustrates a CAD system implemented on a network and including a rights management mechanism according to one embodiment.

FIG. 4 illustrates the components of a rights management mechanism that may be implemented in a CAD system according to one embodiment.

FIG. 5 illustrates the operation of a rights management mechanism implemented in a networked CAD system according to one embodiment.

FIG. 6 is a flowchart illustrating a method of operation of a rights management mechanism implemented in a CAD system according to one embodiment.

FIG. 7 is a flowchart illustrating the operation of a rights client mechanism implemented on a CAD station in a networked CAD system according to one embodiment.

FIG. 8 illustrates an exemplary computer system on which embodiments may be implemented.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Various embodiments of a method and apparatus for dissociating binding information from objects to enable proper rights management are described. Embodiments may provide a rights management mechanism that may be implemented in and/or integrated with Computer-Aided Design (CAD) systems, including network-based CAD systems. The rights management mechanism may be used to establish, manage, and enforce digital rights management for CAD objects. CAD objects may include, but are not limited to, CAD files, including but not limited to CAD assembly, family, and part files, and the objects instantiated from those files, e.g. the assemblies and parts instantiated in a geometric relationship in accordance with binding information into a viewable, structured CAD model, or CAD assembly, in a CAD session. Note that “CAD model” will be referred to as “CAD assembly” herein.

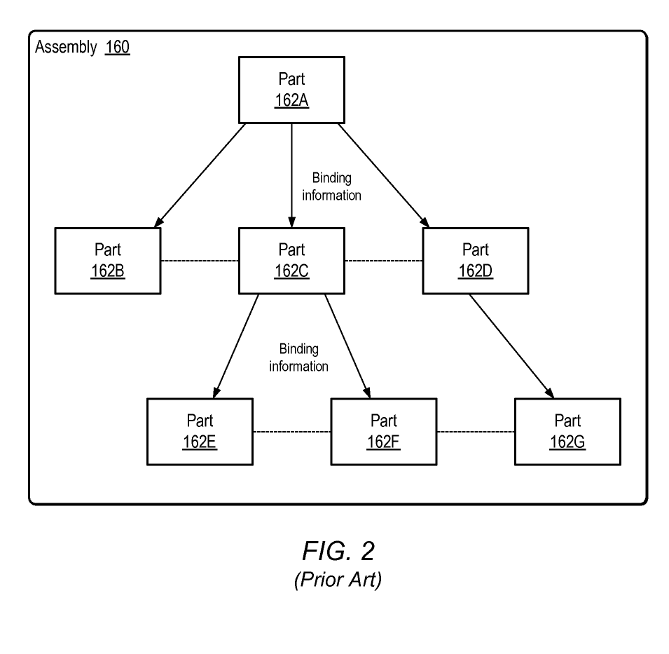

In many CAD systems, including but not limited to CAD systems that enable three-dimensional (3-D) CAD, there is a need to establish, manage, and enforce digital rights management for CAD objects, or parts, within a structured CAD assembly. Particularly in 3-D CAD environments, defining the characteristics and relationships of the components (parts) of CAD assemblies that need to be rights managed is not intuitive. An aspect of the rights management mechanism is that the mechanism dissociates the binding information from the objects (e.g., the parts in the assembly) in a structured CAD assembly to enable proper rights management at the object (part) level in CAD environments. Embodiments of the rights management mechanism manage and enforce digital rights at all levels, including the atomic object level, and at the different levels or tiers of the hierarchy of parts in a CAD assembly (see FIG. 2). Conventional access control and security models for CAD systems generally rely on password protection, and thus do not provide a mechanism for implementing and enforcing rights management at the atomic level within a CAD assembly.

Another aspect of the rights management mechanism is that the mechanism may manage and enforce rights at the user level as well as at the atomic level within a CAD assembly, and may manage and enforce rights at the user level for different CAD functions or operations at the atomic level within a CAD assembly. Thus, different users of a CAD system may be granted different rights for different CAD operations on the individual components within a CAD assembly, with different rights assigned for a particular user to different components within a CAD assembly. This atomic, user-specific rights management enabled by embodiments of the rights management system is not provided in conventional CAD systems.

A simplistic view of a CAD model is that each part is a file on disk. In reality, a CAD model is more than just a set of physical files on disk; a CAD model is the geometric information that is contained in the assembly file and associate part files and how that information is instantiated into a CAD session. The CAD system interprets the geometric information and creates the model or assembly within the context of a CAD session. For example, in an exemplary CAD model of a house, a door may be instantiated from a part file on disk. There may be multiple instances of geometry for the door in the file. Therefore, it is not just a simple matter of knowing just the basic structure of the door; the CAD system must interpret the structure and create the representation of the door according to the correct geometric information in a CAD session. Thus, the nuances in the relationships among the parts in a CAD session may also “define” what the parts in the session are. Thus, parts are instantiated in the context of a CAD session according to the relationships among the parts and have to be understood or interpreted in that context. For example, in the exemplary CAD model of a house, a door is modeled in the context of a house. The context of the door does not make sense outside the context of the house.

Embodiments of the rights management mechanism apply rights management in the context of structured CAD assemblies. In a structured CAD assembly, the CAD model is broken up into a number of objects (parts) in a hierarchical or other structured way (see FIG. 2). For example, a house consists of a roof, doors, windows, etc. In a CAD model, the house may be considered the assembly, and each of the components of the house may be represented as a part. As noted, there is a hierarchical arrangement of parts in a structured CAD assembly. For example, in a CAD model of a house, a high level part may be a room. Going farther down the hierarchy, a next-level part may be a kitchen. The kitchen may include parts that include a sink, counters, cabinets, etc. The relationship among those parts is the binding information. Each of those parts may be individually assigned rights. The rights management mechanism manages the interrelationship among the rights assigned to the different parts. The rights management mechanism provides rights management individually for each part.

The rights management mechanism provides a hierarchical arrangement of, and management of, rights as well. For example one right may be the ability to print parts. One of the parts in an assembly may not have print permission, while the other parts do. The rights management mechanism manages the relationship among the rights so that when the assembly is printed, only the parts with print rights are printed.

Embodiments of the rights management mechanism provide the ability to examine a structured CAD assembly according to the hierarchy of parts, to separate and examine each part and to determine that the part is a specific object that needs to have rights assigned and recognized. That is what is meant by dissociating binding information from an object in a CAD assembly to allow proper rights management. Dissociating objects (parts) of a CAD assembly refers to recognizing the objects in the assembly and separating them out to apply object-level rights management. In dissociating the objects (parts) of a CAD assembly, the rights management mechanism is able to interpret the structure of the assembly and thus to understand the relationships of the parts to each other, and thus can recognize the distinct parts in an assembly.

In embodiments of the rights management system, rights may be managed and applied at the level of CAD files and the content that is contained in the CAD files. Once the geometry in a set of CAD files is instantiated in a CAD session, the rights management system may interpret the geometric relationships among parts and determine that a particular geometry belongs to a particular part and thus to a particular CAD file, and that the part and associated CAD file have certain associated rights. Thus, given the geometry of a CAD session the rights management system is able to determine that that geometry belongs to particular CAD files that have been protected by rights management, and thus apply rights within the session in accordance with the rights assigned to the associated files.

In one embodiment, end users of the CAD system may assign rights based on a file-by-file basis. Those rights may be associated with the content (including the geometric information) of the files on a rights management server. When the files are packaged, the files include information that points them back to the rights management server that stores and manages the rights definitions. The geometry from a set of files that is instantiated into a CAD session may be correlated by the rights management server with the associated files to determine the rights that need to be applied to the parts instantiated from the files.

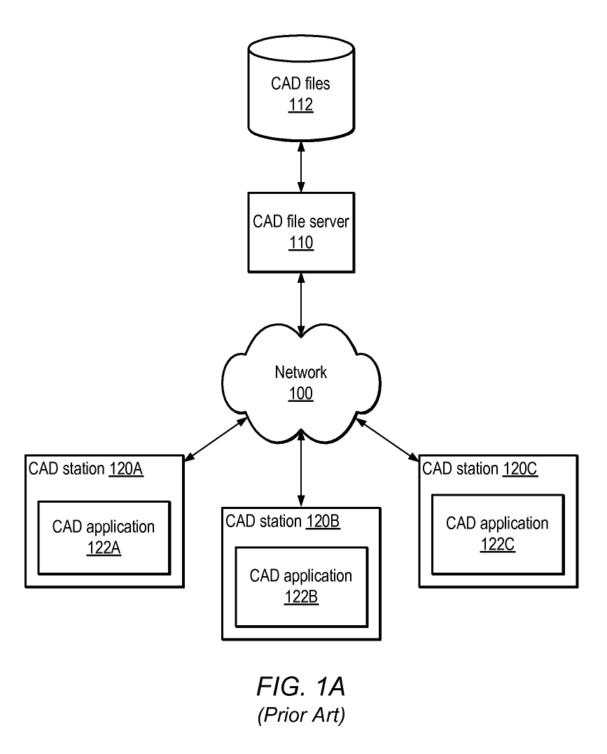

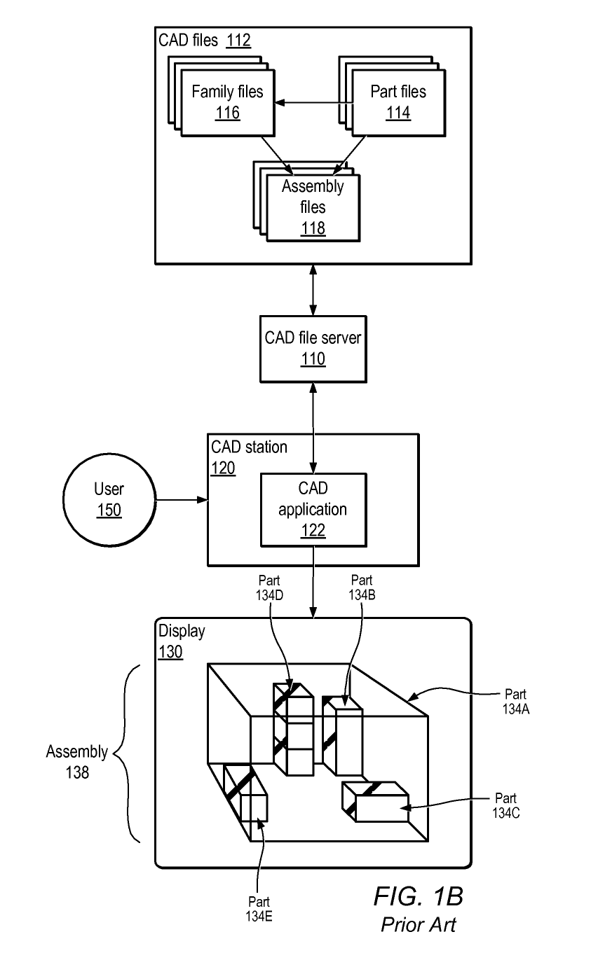

Embodiments of the rights management mechanism may include, but are not limited to, a rights management server and a rights management client, referred to herein as a rights client mechanism. In one embodiment, implemented in a networked CAD system, one or more rights management servers may store and manage rights information for CAD objects, which are typically stored and managed in CAD files on one or more CAD file servers as illustrated in FIGS. 1A and 1B, rights information for the CAD files themselves, and rights information for CAD users. Each CAD station in the networked CAD system may host at least one instance of the rights client mechanism. In one embodiment, the rights client mechanism may be implemented as a plug-in to CAD application software on each CAD station. Implementing the rights client mechanism as a plug-in allows the rights client mechanism to be adapted to function with (“plug in to”) a variety of CAD application software from a variety of vendors. Alternatively, the rights client mechanism may be implemented as a module or component of the CAD application software.

Note that another component of embodiments of the rights management mechanism may be one or more stations or consoles from which an administrator or administrators may perform various administrative functions for the rights management mechanism, including but not limited to defining and modifying the rights, policies, and rules that are to be enforced by the rights management mechanism. For example, if a new CAD user is added to the CAD system, an administrator may define the rights to be granted to the new user; these user rights are stored and managed by the rights management server, and enforced on a CAD station during a CAD session associated with the user by the rights client mechanism.

While the rights management mechanism is described herein in regards to providing rights management in CAD systems, embodiments may be adapted to provide similar rights management to other types of systems.

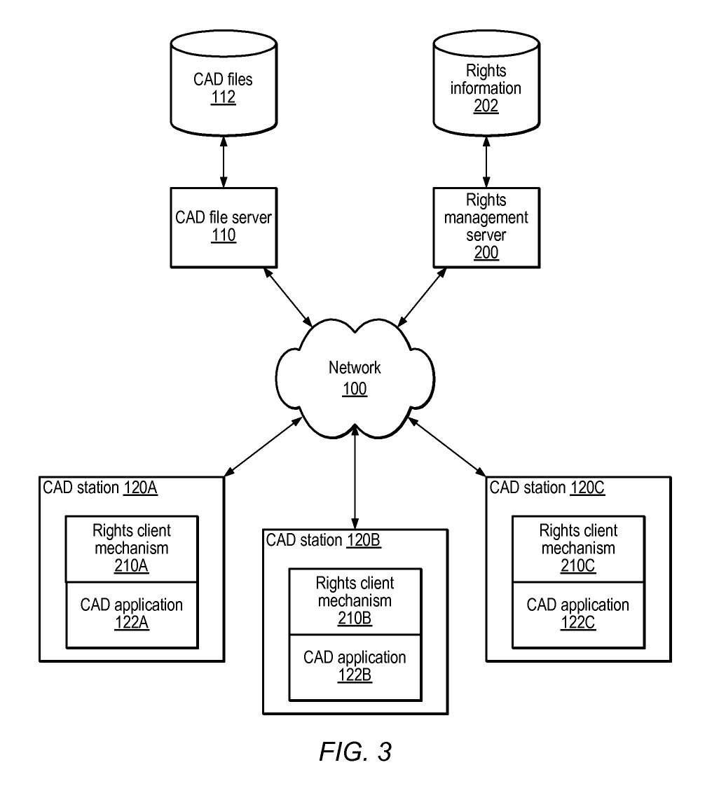

FIG. 3 illustrates an exemplary CAD system implemented on a network and including a rights management mechanism according to one embodiment. One or more CAD stations 120, each implementing CAD software as a CAD application 122, may be coupled to a network 100. A CAD server 110 may be coupled to network 100. CAD server may store and manage CAD files 112. CAD files 112 may include, but are not limited to, assembly files, part files, and family files.

Note that the CAD system software and/or hardware, including CAD stations 120 and CAD applications 122, may be, but are not necessarily, heterogeneous. That is, the CAD system software and/or hardware may be composed of components from one vendor, and the CAD applications 122 may be instances of a particular CAD application from the vendor. Alternatively, a CAD system may include homogeneous hardware and/or software. That is, the CAD system software and/or hardware may be composed of components from two or more vendors. For example, the CAD applications 122 may include instances of CAD applications from different vendors and/or of different versions or types of CAD applications from one vendor. Further note that CAD stations 120 may be high-end CAD workstations designed specifically for CAD, or alternatively may be more generic computer systems capable of hosting and running CAD applications 122. The CAD stations 120 in a CAD system may include a mix of different types of computer devices or workstations from one or more vendors that host CAD applications.

Further, note that different users may work on different CAD stations 120. Each user may have an account or accounts, possibly password-protected or otherwise protected accounts, which enable the user to log into a CAD station 120 and to use the CAD application 122 thereon to participate in the CAD system. A user of a CAD application 122 on a CAD station 120 may access CAD files 112 via CAD server 110. For example a user may access a particular CAD assembly file to render and display the CAD assembly on a CAD station 120A. The CAD application 122A and CAD station 120A may provide different user interface elements and tools that may enable the user to manipulate or modify the displayed CAD assembly, print the CAD assembly, and so on. An embodiment of the rights management mechanism may be used to apply rights management to the displayed CAD assembly for the specific user at the component level of the CAD assembly. Note also that, in a typical CAD system, two or more users on different CAD stations 120 may access the same CAD assembly and/or same CAD parts to render, display, and possibly perform work on the assemblies and parts.

Using embodiments of the rights management mechanism, each user may be assigned user-specific rights for each specific CAD operation at the CAD assembly and/or CAD part level, and the rights management mechanism may be responsible for interpreting and enforcing those rights as applied at the various levels of a particular CAD assembly rendered on a CAD station 120 for particular CAD operations on the assembly and parts thereof. For example, one user may have rights to display and print a particular part of an assembly, while another user may have the right to display but not to print the particular part. As another example, one user may be granted global rights that allow the user to access and perform any CAD operation on any assembly or part in the CAD system, while another user may be granted limited rights that only allow the user to display and view the assemblies. As another example, a particular user may be granted rights that allow the user to access and perform any CAD operation on a subset of the assemblies and/or parts, but the user may have limited rights to access and/or perform CAD operations on the rest of the assemblies and/or parts. As another example, a particular user may be granted rights to access, render, display, manipulate, and even modify a particular assembly, including the parts in the assembly, but may not have rights to perform at least some CAD operations on one or more specific parts of the assembly.

Note that, while rights are generally described herein as being assigned and managed for users and for CAD assemblies and parts, in one embodiment, rights may be assigned to or associated with particular CAD stations 120 and/or particular instances of CAD application 122. In other words, the rights management mechanism may associate particular rights with a particular CAD station 120 or application 122, and deny or allow specific CAD operations on some or all CAD assemblies and/or parts to any user of that CAD station 120 or application 122.

An implementation of the rights management mechanism in a networked CAD system may include, but is not limited to, at least one rights management server 200 and one or more rights client mechanisms 210. Rights management server 200 may store and manage rights information 202. Rights information 202 may include one or more of, but is not limited to, rights information for CAD objects, rights information for the CAD files 112, and rights information for CAD users.

Each CAD station 120 in the networked CAD system may host an instance of the rights client mechanism 210. In one embodiment, the rights client mechanism 210 may be implemented as a plug-in to CAD application 122 on each CAD station 120. Alternatively, the rights client mechanism 210 may be implemented as a module or component of the CAD application 122 software. An instance of the rights client mechanism 210 on a CAD station 120 may be responsible for dissociating binding information from objects (e.g., parts) in a CAD assembly currently displayed on the CAD station 120 and on which an operation for which rights management is to be applied has been initiated. Note that the operation may have been, but is not necessarily, initiated by a user of the CAD application 122 on the CAD station 120. Thus, the rights client mechanism 210 may intercept or otherwise access an initiated operation on the CAD station 120, and in response to the initiated operation act to apply the proper rights management at all levels, including the atomic object level, of the CAD assembly and for the particular user that initiated the operation.

Dissociating binding information from the objects in the CAD assembly may allow the rights client mechanism 210 to identify each atomic object (e.g., each individual part) of the CAD assembly that may be affected by the initiated operation. The rights client mechanism 210 may then access the rights management server 200 via network 100 to obtain the rights information associated with the CAD assembly, relevant objects (e.g. relevant parts) of the CAD assembly, the user of the CAD application 122, and with the particular operation. The rights client mechanism 210 may then allow or disallow the initiated operation at the atomic level of the CAD assembly in accordance with the obtained rights information. For example, the operation may be a print operation to print the CAD assembly; the rights information may indicate that the particular user has the appropriate rights to print the CAD assembly but does not have the rights to print one or more of the parts included in the assembly. The CAD assembly may then be printed to an indicated printer, but the one or more parts that the user does not have the rights to print are not printed. Note that the “space” where the parts would be may be blank, or alternatively an outline or other indication of “missing parts” may be printed, and some message such as “Access rights denied” or “You do not have print rights to Part abc” or some other such message may be conveyed to the user.

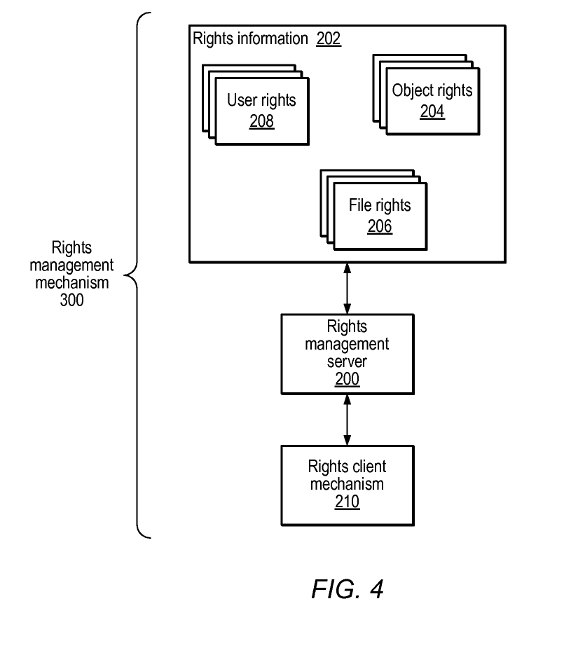

FIG. 4 illustrates the components of an exemplary rights management mechanism that may be implemented in a CAD system according to one embodiment. An implementation of the rights management mechanism 300 may include, but is not limited to, at least one rights management server 200, rights information 202, and one or more rights client mechanisms 210. Rights management server 200 may store and manage rights information 202. Rights information 202 may include one or more of, but is not limited to, rights information for CAD objects (object rights 204), rights information for CAD files (file rights 206), and rights information for CAD users (user rights 208). Note that the rights information as indicated for the objects and/or files may be specific to particular CAD operations for particular users.

The rights information 202 may be stored and managed using any of a variety of methods, or combination of two or more thereof, for storing and associating information. Note that the rights information 202 may be viewed as a definition of a rights policy for the CAD system that is stored and managed by the rights management server 200 and enforced at the CAD station level by the rights client mechanism 210. Further note that, while FIG. 4 shows the object rights 204, file rights 206, and user rights 208 as separate elements, in various embodiment, the rights information may be stored and managed in one or more data structures. Further note that, in some embodiments, other rights may be defined in rights information 202. For example, in one embodiment, rights information 202 may define rights at the CAD station level that allow or restrict specific operations from being performed on particular CAD stations, or even by particular users at particular CAD stations. In the latter case, for example, rights information 202 may define a policy whereby a particular user may perform some operations on CAD objects on a particular CAD station but not on other CAD stations.

Rights information 202 may be organized so that policies may be established, managed, retrieved, and enforced for specific users performing specific operations on specific CAD files, assemblies and parts in CAD sessions. Thus, rights information 202 may define what operations particular users may or may not perform on particular files, parts, and/or assemblies in a CAD session. An alternative way to view rights information 202 is that rights information 202 may define which users may or may not perform which operations on which CAD objects in a CAD session.

The following provides an exemplary and high-level view of how rights information 202 may be organized. Note that this is exemplary, and is not intended to be limiting.

In one embodiment, rights information may include, but is not limited to, something conceptually like the following that defines “global” rights for particular users:

<User 1>
Rights: access any, modify any, print any, copy any, delete any, ....
<User 2>
Rights: access any, modify by permission, print any, copy by permission,
no delete, ....
<User 3>
Rights: access by permission, no modify, print by permission, copy by
permission, no delete,
....
....
<User n>
Rights: ....

“By permission” in the above may refer to whether the rights information for the object in question (e.g., an assembly or part) indicates that the particular user may or may not perform the particular operation on the object. For example, if a user's rights indicate “access by permission”, the user may only be able to open an assembly file to render and display an assembly on a CAD station if the assembly file's associated file rights 206 indicate that the user has permission to open the file. Continuing with the example, if the user's rights indicate “print by permission”, the user may only be able to print the assembly if the assembly's associated object rights 204 indicate that the user has permission to print the assembly. Continuing with the example, if the user's rights indicate “print by permission”, the user may be able to print the assembly if the assembly's associated rights information grants the user rights to print the assembly. However, the user may not be able to print one or more parts of the assembly if the parts' associated object rights 204 indicate that the user does not have permission to print the one or more parts.

In one embodiment, rights information may include, but is not limited to, something conceptually like the following that defines rights for particular users in regards to particular objects, for example assemblies and parts:

```
<Assembly 1>
    <User 1> rights: display, modify, print, copy, delete, ....
    <User 2> rights: display, print
    <User 3> rights: none
    <User 4> rights: display, print, copy
<Assembly 2>
    <User 1> rights: display, modify, print, copy, delete, ....
    <User 2> rights: display, modify, print, copy
    <User 3> rights: none
    <User 4> rights: display, print
<Part 1>
    <User 1> rights: display modify, print, copy, delete, ....
    <User 2> rights: display modify, print
    <User 3> rights: display, print, copy
    <User 4> rights: display
<Part 2>
    <User 1> rights: display, modify, print, copy, delete, ....
    <User 2> rights: display, modify, print, copy
    <User 3> rights: none
    <User 4> rights: display, print
....
```

Note again that the above are exemplary of what rights information 202 may include and how rights information 202 may be organized, and are not intended to be limiting. Other rights may be included, and other methods of organizing the rights information 202 may be used. Note, however, that the rights management mechanism 300 stores, organizes, and manages rights information 202 in such a way that rights may be identified and applied in a CAD session at the atomic level of CAD models (assemblies) and in accordance with defined policies for specific users.

In addition to a CAD system including at least one instance of a rights management server 200 and rights information 202, each CAD station in a CAD system may host at least one instance of rights client mechanism 210. In one embodiment, the rights client mechanism 210 may be implemented as a plug-in to a CAD application on each CAD station. Alternatively, the rights client mechanism 210 may be implemented as a module or component of the CAD application software on a CAD station.

Embodiments of rights management mechanism 300 may include one or more other components. For example, an implementation of rights management mechanism 300 may include one or more stations or consoles from which an administrator or administrators may perform various administrative functions for the rights management mechanism 300 within the CAD system, including but not limited to defining and modifying the rights, policies, and rules that are to be enforced by the rights management mechanism 300.

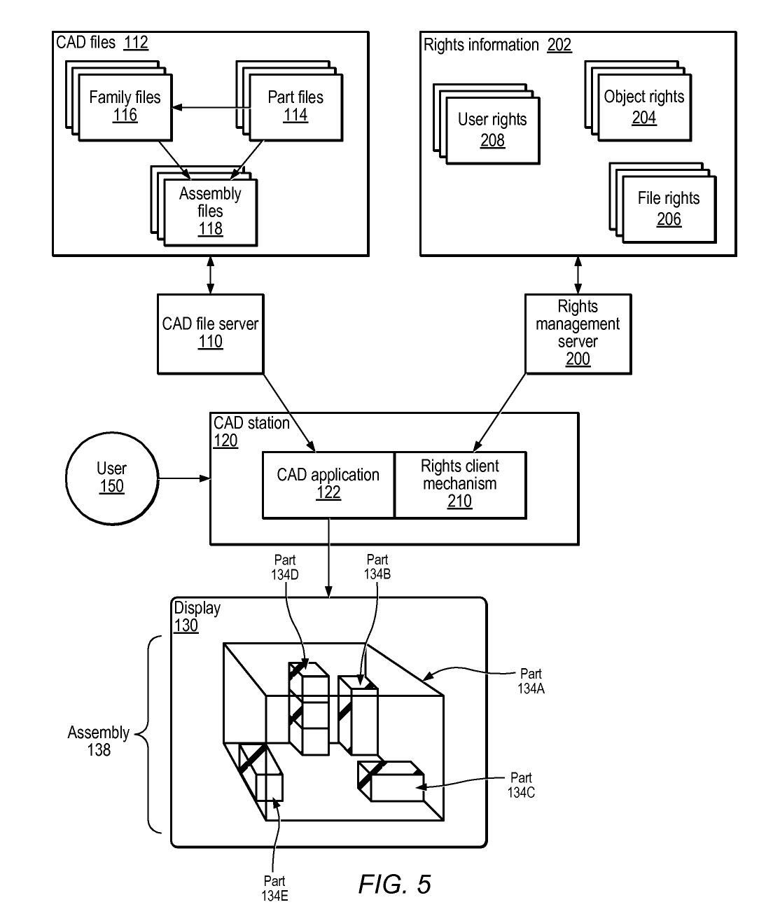

FIG. 5 illustrates the operation of a rights management mechanism implemented in a networked CAD system according to one embodiment. A user 150 may interact with CAD application 122 implemented on CAD station 120 to initiate CAD operations. CAD station 120 may host an instance of rights client mechanism 210. In one embodiment, rights client mechanism 210 may be implemented as a plug-in to CAD application 122 on CAD station 122. Alternatively, rights client mechanism 210 may be implemented as a module or component of CAD application 122.

For example, the user 150 may interact with CAD application 122 to initiate an operation to open and display a particular CAD assembly 138. An assembly 138 may be considered a geometrically ordered or related collection of parts 134 that may be rendered and displayed on a CAD station 120 by a CAD application 122 from the information contained in an assembly file 118. The assembly file 118 may reference other CAD files 112, such as one or more part files 114 and/or one or more family files 116. The assembly file 118 may include information related to the geometric relationships among the parts 134 indicated therein, and possibly other information related to the assembly 138. Each part file 114 may include information, including but not limited to geometric information, related to a particular part 134. A family file 116 may be a file that indicates a collection of one or more part files 114, and may include other information such as information about relationships among the parts 138 indicated therein.

In response to user 150 initiating an operation to open and display assembly 138, CAD application 122 may be configured to communicate with CAD server 110 to access the assembly file 118 for the desired assembly 138. In on embodiment, rights client mechanism 210 may intercept or otherwise access the operation in order to determine the rights of user 150 in regards to the assembly file 118. Rights client mechanism 210 may access the associated file rights 206 and/or user rights 208 in rights information 202 via communications with rights management server 200 to determine if user 150 has the appropriate rights to access (open) the associated assembly file 118 and to thus display assembly 138 on CAD station 120. Similarly, rights client mechanism 210 may access the associated file rights 206 and/or user rights 208 in rights information 202 via communications with rights management server 200 to determine if user 150 has the appropriate rights to access (open) the associated part file(s) 114 and/or family file(s) 116 to display the various parts 134 of assembly 138 on CAD station 120.

If the rights client mechanism 210 determines that user 150 has the appropriate rights to access the assembly file 118 and display the assembly 138, rights client mechanism 210 may allow CAD application 122 to access the assembly file 118 via the CAD server 110 and render the assembly 138 on a display 130 coupled to the CAD station 120 using the part 134 information and geometric relationship information (binding information) included in the assembly file 118 and referenced part files 114. In this example, assembly 138 has been rendered on display 130 as a 3-D model that includes, in this view of the assembly 138, parts 134A through 134E ordered according to a geometric relationship as specified in the assembly file 118.

If the rights client mechanism 210 determines that user 150 does not have the appropriate rights to access the assembly file 118, the rights client mechanism 210 may prevent CAD application 120 from opening and displaying the assembly 138. If the rights client mechanism 210 determines that user 150 has the appropriate rights to access the assembly file 118 but not one or more of the part files 114 indicated by the assembly file 118, the rights client mechanism 210 may allow CAD application 120 to open and display the assembly 138 but not the one or more parts 134 thereof for which the user 150 does not have the appropriate rights.

Once assembly 138 is displayed on display 130, user 150 may then need or desire to manipulate, modify, or perform other types of operations on the assembly 138 or parts 134 via a user interface to CAD application 122 on CAD station 120. For example, the user 150 may need or desire to add or remove parts 134, move parts 134, modify parts 134, print the assembly 138 or portions thereof, rotate or otherwise change the perspective or view of the assembly 138, view other aspects of the assembly 138 not currently displayed, copy the assembly 138 or one or more parts of the assembly 138 to a storage medium, forward or copy the assembly 138 via the network to some remote destination, change characteristics or geometric relationships of the parts 134 of the assembly, and so on.

The user 150 may interact with CAD application 122 to initiate an operation on CAD assembly 138 or one or more parts 134 thereof. In response to user 150 initiating an operation, rights client mechanism 210 may intercept or otherwise access the operation in order to determine the rights of user 150 in regards to performing the particular operation on the assembly 138 and/or part(s) 134 included in the assembly 138. The rights client mechanism 210 may dissociate the binding information of the assembly 138 from the parts 134 of the assembly 138 to identify, at the atomic level, the parts 134 of the assembly 138 affected by the operation. Rights client mechanism 210 may then access the object rights 204 associated with the assembly 138 and identified parts 138, and/or may access user rights 208, via communications with rights management server 200 to determine if user 150 has the appropriate rights to perform the operation at the assembly 138 and part 134 level for the affected parts 134. If the rights client mechanism 210 determines that user 150 has the appropriate rights to perform the operation at the assembly 138 and part 134 level, rights client mechanism 210 may allow CAD application 122 to perform the operation on the assembly 138 and affected parts. If the rights client mechanism 210 determines that user 150 has the appropriate rights to perform the operation at the assembly 138 level but not at the part 134 level for one or more of parts 134 of assembly 138, rights client mechanism 210 may allow CAD application 122 to perform the operation on the assembly 138 and some of the parts 134 thereof, but not on the one or more parts 134 for which the user 150 does not have the appropriate rights. If the rights client mechanism 210 determines that user 150 does not have the appropriate rights to perform the operation at the assembly 138 level, rights client mechanism 210 may prohibit CAD application 122 from performing the operation.

As an example, user 150 may initiate a print operation via CAD application 122 to print assembly 138 on a local or remote printer. Rights client mechanism 210 may access the associated object rights 204 and/or user rights 208 in rights information 202 via communications with rights management server 200 to determine if user 150 has print rights for assembly 138 and for each of the parts 134 of assembly 138. If user 150 has print rights for assembly 138 and for each of the parts 134 of assembly 138, CAD application 122 may be allowed to print assembly 138 (or the current view of the assembly 138) and the parts 134 of assembly 138. If user 150 has print rights for assembly 138 and for each of the parts 134 of assembly 138 except part 134B, CAD application 122 may be allowed to print assembly 138 (or the current view of the assembly 138) and all of the parts 134 of assembly 138 except part 134B.

As another example, user 150 may initiate a copy operation via CAD application 122 to copy assembly 138 to a local storage medium or via a network to a remote destination. Rights client mechanism 210 may access the associated object rights 204 and/or user rights 208 in rights information 202 via communications with rights management server 200 to determine if user 150 has the appropriate rights to make a local or remote copy of assembly 138 and each of the parts 134 of assembly 138. If user 150 has the appropriate rights to copy assembly 138 and each of the parts 134 of assembly 138, CAD application 122 may be allowed to copy assembly 138 and the parts 134 of assembly 138 to the indicated local or remote destination. If user 150 has the appropriate rights to copy assembly 138 and each of the parts 134 of assembly 138 except part 134B, CAD application 122 may be allowed to copy assembly 138 and the parts 134 of assembly 138 to the indicated local or remote destination with the exception of part 134B.

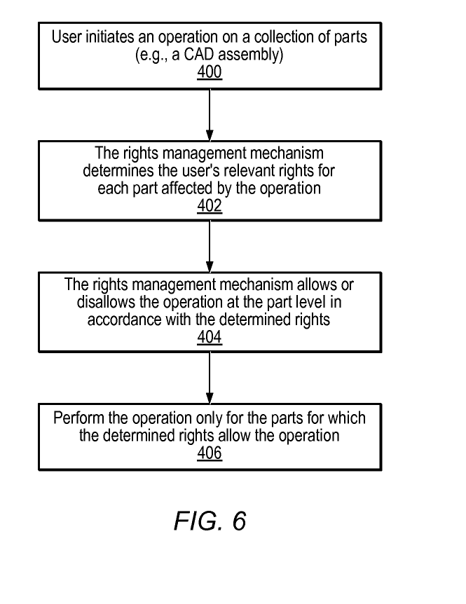

FIG. 6 is a flowchart illustrating a method of operation of a rights management mechanism implemented in a CAD system according to one embodiment. As indicated at 400, a user initiates an operation on a collection of parts (e.g., a CAD assembly) via a CAD application instance on a CAD station. As indicated at 402, the rights management mechanism determines the user's relevant rights for each part affected by the operation. As indicated at 404, the rights management mechanism allows or disallows the operation at the part level in accordance with the determined rights. For example, the operation may be a print operation, and the user may be allowed by the rights management mechanism to print the assembly and its parts, or may be allowed to print the assembly and some of its parts, but not one or more parts for which the user does not have print rights. The CAD application may then perform the operation only for the parts for which the determined rights allow the operation, as indicated at 406.

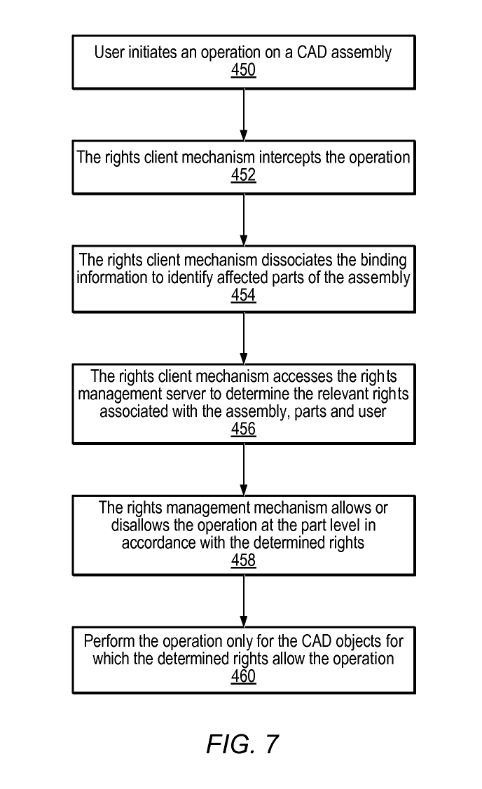

FIG. 7 is a flowchart illustrating the operation of a rights client mechanism implemented on a CAD station in a networked CAD system according to one embodiment. As indicated at 450, a user initiates an operation on a collection of parts (e.g., a CAD assembly) via a CAD application instance on a CAD station. An instance of the rights client mechanism intercepts the operation on the CAD station, as indicated at 452. The rights client mechanism then dissociates the binding information from the parts of the assembly to identify, at the atomic level, the affected parts of the assembly, as indicated at 454. In one embodiment, to dissociate binding information from the parts of a CAD assembly, the rights client mechanism may be configured to dissociate geometric information associated with the parts to determine geometric information specific to each part. As indicated at 456, the rights client mechanism accesses the rights management server to determine the relevant rights associated with the assembly, identified parts, and user. In one embodiment, the rights management server may store rights information associated with a plurality of CAD files including part files. The rights management server receive information specific to a part from the rights client mechanism. The rights management server may then identify a file associated with the part from the information specific to the part, and determine the rights associated with the part from the rights assigned to the file associated with the part. As indicated at 458, the rights management mechanism then allows or disallows the operation at the part level in accordance with the determined rights. The CAD application may then perform the operation only for the CAD objects for which the determined rights allow the operation, as indicated at 460.

### Exemplary System

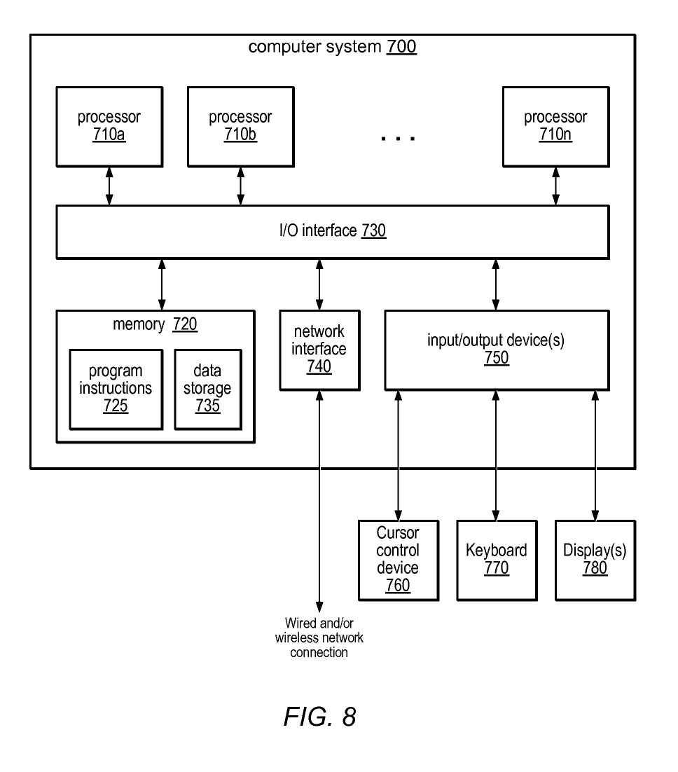

Various components of embodiments of a rights management mechanism as described herein may be executed on one or more computer systems, which may interact with various other devices. One such computer system is illustrated by FIG. 8. In the illustrated embodiment, computer system 700 includes one or more processors 710 coupled to a system memory 720 via an input/output (I/O) interface 730. Computer system 700 further includes a network interface 740 coupled to I/O interface 730, and one or more input/output devices 750, such as cursor control device 760, keyboard 770, audio device 790, and display(s) 780. In some embodiments, it is contemplated that embodiments may be implemented using a single instance of computer system 700, while in other embodiments multiple such systems, or multiple nodes making up computer system 700, may be configured to host different portions or instances of embodiments. For example, in one embodiment some elements may be implemented via one or more nodes of computer system 700 that are distinct from those nodes implementing other elements.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments, processors 710 may be general-purpose or embedded processors implementing any of a variety of instruction set architectures (ISAs), such as the x86, PowerPC, SPARC, or MIPS ISAs, or any other suitable ISA. In multiprocessor systems, each of processors 710 may commonly, but not necessarily, implement the same ISA.

System memory 720 may be configured to store program instructions and/or data accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for the rights management mechanism, are shown stored within system memory 720 as program instructions 725 and data storage 735, respectively. In other embodiments, program instructions and/or data may be received, sent or stored upon different types of computer-accessible media or on similar media separate from system memory 720 or computer system 700. Generally speaking, a computer-accessible medium may include storage media or memory media such as magnetic or optical media, e.g., disk or CD/DVD-ROM coupled to computer system 700 via I/O interface 730. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 740.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. In addition, in some embodiments some or all of the functionality of I/O interface 730, such as an interface to system memory 720, may be incorporated directly into processor 710.

Network interface 740 may be configured to allow data to be exchanged between computer system 700 and other devices attached to a network, such as other computer systems, or between nodes of computer system 700. In various embodiments, network interface 740 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or retrieving data by one or more computer system 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

As shown in FIG. 8, memory 720 may include program instructions 725, configured to implement embodiments of the rights management mechanism as described herein, and data storage 735, comprising various data accessible by program instructions 725. In one embodiment, program instructions 725 may include software elements of a rights management mechanism as illustrated in FIGS. 3, 4 and 5. Data storage 735 may include data that may be used in some embodiments. In other embodiments, different software elements and data may be included.

Those skilled in the art will appreciate that computer system 700 is merely illustrative and is not intended to limit the scope of the rights management mechanism as described herein. In particular, the computer system and devices may include any combination of hardware or software that can perform the indicated functions, including computers, network devices, internet appliances, PDAs, wireless phones, pagers, etc. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc. As well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A computer-implemented method, comprising:
dissociating binding information from a plurality of parts of a Computer-Aided Design (CAD) assembly instantiated on a CAD station in response to an operation initiated on the CAD assembly;
determining rights associated with each of the plurality of parts affected by the operation; and
enforcing the determined rights for each of the plurality of parts affected by the operation individually.

2. The method as recited in claim 1, wherein the operation is initiated on the CAD assembly by a user of the CAD station, wherein the determined rights for each of the plurality of parts affected by the operation are specific to the user.

3. The method as recited in claim 1, wherein the determined rights for each of the plurality of parts affected by the operation are specific to the operation.

4. The method as recited in claim 1, wherein the operation is initiated on the CAD assembly by a user of the CAD station, wherein the determined rights for each of the plurality of parts affected by the operation are specific to the operation and to the user.

5. The method as recited in claim 1, wherein the operation is initiated on the CAD assembly by a user of the CAD station, wherein said enforcing the determined rights for each of the plurality of parts affected by the operation individually comprises:
allowing the operation on each part for which the user has the right to perform the operation; and
not allowing the operation on each part for which the user does not have the right to perform the operation.

6. The method as recited in claim 1, wherein said dissociating binding information from a plurality of parts of a CAD assembly comprises dissociating geometric information associated with the plurality of parts to determine geometric information specific to each part.

7. The method as recited in claim 6, wherein said determining rights associated with each of the plurality of parts affected by the operation comprises, for each part:
identifying a file associated with the part from geometric information specific to the part; and
determining rights associated with the part from rights assigned to the file associated with the part.

8. A Computer-Aided Design (CAD) system, comprising:
a CAD file server configured to store CAD files including part files and assembly files;
a rights management server configured to store rights information associated with the CAD files on the CAD server; and
one or more CAD stations each comprising:
an instance of a CAD application; and
an instance of a rights client mechanism;
wherein the rights client mechanism is configured to:
dissociate binding information from a plurality of parts of a CAD assembly instantiated on the CAD station by the CAD application from one or more CAD files accessed from the CAD file server in response to an operation initiated on the CAD assembly;
access the rights management server to determine rights associated with each of the plurality of parts affected by the operation; and
enforce the determined rights for each of the plurality of parts affected by the operation individually.

9. The CAD system as recited in claim 8, wherein the operation is initiated on the CAD assembly by a user of the CAD station, wherein the determined rights for each of the plurality of parts affected by the operation are specific to the operation and to the user.

10. The CAD system as recited in claim 8, wherein the operation is initiated on the CAD assembly by a user of the CAD station, wherein to enforce the determined rights for each of the plurality of parts affected by the operation individually, the rights client mechanism is configured to:
allow the operation on each part for which the user has the right to perform the operation; and
not allow the operation on each part for which the user does not have the right to perform the operation.

11. The CAD system as recited in claim 8, wherein, to dissociate binding information from a plurality of parts of a CAD assembly, the rights client mechanism is configured to dissociate geometric information associated with the plurality of parts to determine geometric information specific to each part, and wherein, to access the rights management server to determine rights associated with each of the plurality of parts affected by the operation, the rights client mechanism is configured to, for each part, send geometric information specific to the part to the rights management server.

12. The CAD system as recited in claim 11, wherein the rights management server is configured to:
identify a file associated with the part from the geometric information specific to the part received from the rights client mechanism;
determine rights associated with the part from rights assigned to the file associated with the part; and
provide the determined rights associated with the part to the rights client mechanism.

13. A Computer-Aided Design (CAD) station, comprising:
at least one processor; and
a memory comprising program instructions, wherein the program instructions are executable by the at least one processor to:
dissociate binding information from a plurality of parts of a Computer-Aided Design (CAD) assembly instantiated on the CAD station in response to an operation initiated on the CAD assembly;
determine rights associated with each of the plurality of parts affected by the operation; and
enforce the determined rights for each of the plurality of parts affected by the operation individually.

14. The CAD station as recited in claim 13, wherein the operation is initiated on the CAD assembly by a user of the CAD station, wherein the determined rights for each of the plurality of parts affected by the operation are specific to the operation and to the user.

15. The CAD station as recited in claim 13, wherein the operation is initiated on the CAD assembly by a user of the CAD station, wherein, to enforce the determined rights for each of the plurality of parts affected by the operation individually, the program instructions are further executable to:
allow the operation on each part for which the user has the right to perform the operation; and
not allow the operation on each part for which the user does not have the right to perform the operation.

16. A system, comprising:
at least one processor; and
a memory comprising program instructions, wherein the program instructions are executable by the at least one processor to:
store rights information associated with a plurality of Computer-Aided Design (CAD) files including part files;
receive information specific to a part from a CAD station;
identify a file associated with the part from the information specific to the part;
determine rights associated with the part from rights assigned to the file associated with the part; and
return the determined rights associated with the part to the CAD station.

17. A computer-readable storage medium, comprising program instructions, wherein the program instructions are computer-executable to implement:
dissociating binding information from a plurality of parts of a Computer-Aided Design (CAD) assembly instantiated on a CAD station in response to an operation initiated on the CAD assembly;
determining rights associated with each of the plurality of parts affected by the operation; and
enforcing the determined rights for each of the plurality of parts affected by the operation individually.

18. The computer-readable storage medium as recited in claim 17, wherein the operation is initiated on the CAD assembly by a user of the CAD station, wherein the determined rights for each of the plurality of parts affected by the operation are specific to the operation and to the user.

19. The computer-readable storage medium as recited in claim 17, wherein the operation is initiated on the CAD assembly by a user of the CAD station, wherein, in said enforcing the determined rights for each of the plurality of parts affected by the operation individually, the program instructions are further computer-executable to implement:
allowing the operation on each part for which the user has the right to perform the operation; and
not allowing the operation on each part for which the user does not have the right to perform the operation.

20. The computer-readable storage medium as recited in claim 17, wherein, in said dissociating binding information from a plurality of parts of a CAD assembly, the program instructions are further computer-executable to implement dissociating geometric information associated with the plurality of parts to determine geometric information specific to each part.

21. The computer-readable storage medium as recited in claim 20, wherein, in said determining rights associated with each of the plurality of parts affected by the operation, the program instructions are further computer-executable to implement, for each part:
identifying a file associated with the part from geometric information specific to the part; and
determining rights associated with the part from rights assigned to the file associated with the part.
